(19) United States
(12) Patent Application Publication
(10) Pub. No.: US 2012/0282519 A1
(43) Pub. Date: Nov. 8, 2012

(54) Dissimilar Material Battery Enclosure for Improved Weld Structure

(75) Inventors: Gary Freitag, East Aurora, NY (US); Xiangyang Dai, East Amherst, NY (US); Mark Roy, Buffalo, NY (US); Robert S. Rubino, Williamsville, NY (US)

(73) Assignee: Greatbatch Ltd., Clarence, NY (US)

(21) Appl. No.: 13/463,936

(22) Filed: May 4, 2012

Related U.S. Application Data
(60) Provisional application No. 61/483,319, filed on May 6, 2011.

(51) Int. Cl. H01M 2/04; H01M 2/08

(52) U.S. Cl. 429/181; 429/163; 29/623.2

(57) ABSTRACT

An electrochemical cell having an enclosure comprised of an enclosure body portion composed of a relatively high electrical resistivity material and an enclosure lid portion composed of a ductile material is discussed. The body portion of the enclosure preferably comprises Grade 5 or 23 titanium and the lid portion preferably comprises Grade 1 or 2 titanium. The enclosure lid is joined to the body of the enclosure through a welding process such as laser welding. The combination of these differing materials provides an enclosure that effectively retards the occurrence of eddy current induced heating as well as provides an enclosure that is more mechanically robust.

### CROSS-REFERENCE TO RELATED APPLICATIONS

This application claims priority from U.S. Provisional Patent Application Ser. No. 61/483,319, filed May 6, 2011.

### FIELD OF THE INVENTION

The present invention relates to the art of electrochemical cells, and more particularly, to an improved electrochemical cell comprising dissimilar metals. More specifically, the present invention is of an electrochemical cell and manufacturing process thereof comprising an electrochemical enclosure composed of dissimilar metals.

### PRIOR ART

The recent rapid development in small-sized electronic devices having various shape and size requirements requires comparably small-sized electrochemical cells of different designs that can be easily manufactured and used in these electronic devices. Preferably, the electrochemical cell has a high energy density of a robust construction. Such electrochemical cells are commonly used to power automated implantable medical devices (AIMD) such as pacemakers, neurostimulators, defibrillators and the like.

One commonly used cell configuration is a secondary or rechargeable electrochemical cell. These secondary electrochemical cells are designed to reside within the medical device and remain implanted within the body over long periods of time of up to 5 to 10 years or more. As such, these secondary electrochemical cells are required to be recharged from time to time to replenish electrical energy to the cell and power the medical device.

Secondary electrochemical cells, such as those used to power automated implantable medical devices, are commonly recharged through an inductive means whereby energy is wirelessly transferred from an external charging device through the body of the patient to the cell residing within the AIMD. Electro-magnetic (EM) induction, in which EM fields are sent by an external charger to the cell within the AIMD is a common means through which the electrochemical cell is recharged. Thus, when the electrochemical cell requires recharging, the patient can activate the external charger to transcutaneously (i.e., through the patient's body) recharge the cell.

During the recharging process, a portion of the external charging unit comprising a plurality of charging coils is generally placed near the AIMD outside the patient's body. Due to this close proximity, the magnetic field produced by the charge coil(s) may induce eddy current heating of the electrochemical cell enclosure or casing. Eddy current heating of the electrochemical cell enclosure generally occurs when eddy currents, emanating from the charging coil, interact with the conductive material of the enclosure. This interaction generates heat therewithin.

Eddy current heating results when a conductive material experiences changes in a magnetic field. In the case of recharging an electrochemical cell within an implanted medical device, eddy current heating occurs as the varying magnetic fields emanating from the coils of the external charging unit move past the stationary cell enclosure. Eddy current heating is proportional to the strength of the magnetic field and the thickness of the conductive material. In addition, eddy current heating is inversely proportional to electrical resistivity and density of the material. Therefore, eddy current heating can be reduced by lowering the intensity of the magnetic field and the use of a material of increased electrical resistivity and reduced thickness.

Over a period of time, as the AIMD is recharged, the phenomena of eddy current heating therefore may result in excessive heating of the cell enclosure. This, therefore, could adversely affect the function of the electrochemical cell and/or the AIMD within which it resides.

Currently, device recharging rates and recharge time intervals must be limited to minimize the possibility of excessive heating. This results in reduced battery charge capacities which, therefore, increases the charging time interval. In addition, the number of electrochemical cell recharging events may need to be increased to compensate for the reduced charge capacity. Therefore, the patient is required to recharge the electrochemical cell more frequently and for longer periods of time equating to an overall longer period of recharging time.

Therefore, what is desired is an electrochemical enclosure that minimizes eddy current heating and thus allows for increased charge rates and reduced charging times. In an embodiment of the present invention, the reduction of eddy current heating is accomplished through the use of an enclosure composed of a material comprising a relatively high electrical resistivity. Examples of such materials include Grades 5 and 23 titanium which comprise various amounts of vanadium and aluminum. Specifically, these grades of titanium comprise about four percent vanadium and about six percent aluminum. As such, these materials exhibit relatively high electrical resistivity, which minimize eddy current heating.

However, these grades of titanium are generally known to be more refractive as compared to other materials, particularly other titanium alloys and, therefore, to exhibit an increased brittleness and hardness. As a result, forming an enclosure of Grade 5 or 23 titanium is difficult. For example, forming processes used during the manufacture of an electrochemical cell enclosure such as drawing, forming, rolling, stamping and punching are limited due to the material's increased brittle properties.

Furthermore, the ability to withstand case deformation caused by normal swelling of the electrochemical cell over time is also limited. Such swelling and repeated stress cycling due to repeated charge-discharge cycles may crack the enclosure or cell case, which may result in a breach of the cell's hermetic seal. Such a loss of hermeticity could allow for leakage of material from within the cell that could damage the AIMD.

Therefore, what is needed is an electrochemical cell enclosure that is both mechanically robust and resistive to eddy current heating. The present invention addresses the shortcomings of the prior art by providing an electrochemical cell comprising an enclosure that is both resistive to eddy current heating, mechanically robust and easily manufacturable.

### SUMMARY OF THE INVENTION

The present invention relates to an electrochemical cell and method of manufacture thereof comprising an enclosure composed of a combination of dissimilar materials. Specifically, the enclosure of the electrochemical cell comprises a main enclosure body portion composed of a relatively high electrical resistivity material, such as Grade 5 or 23 titanium and an enclosure lid portion composed of a more ductile material, such as Grade 1 or 2 titanium. The enclosure lid is joined to the body of the enclosure through a welding process such as laser welding.

The combination of these differing materials provides an enclosure that effectively retards the occurrence of eddy current heat as well as provides an enclosure that is more mechanically robust. Specifically, the electrochemical cell enclosure of the present invention is a combination of eddy current resistive Grade 5 or 23 titanium metals with that of the more ductile Grade 1 or 2 titanium metals, thereby providing an electrochemical enclosure that is both resistive to eddy currents and mechanically tough.

The joining of a more ductile material, such as Grade I or 2 titanium, to the more brittle Grade 5 or 23 titanium, blends the added benefits of each of the opposing material properties. Specifically, the eddy current induced heating is retarded by use of an enclosure body portion of increased ductility joined to a lid portion in a hermetic manner. In particular, the titanium alloy formed at the weld joint between these two diverse materials exhibits mechanical properties that lie between the extremes of the two opposing titanium grades. A titanium composite material that is both mechanically strong and durable is formed where the different titanium grades are joined. Therefore, the enclosure of the electrochemical cell is more able to expand and contract to withstand the mechanical stresses of cell swelling as well as provide a more robust cell design that is able to endure subsequent processing steps.

Within the enclosure body of the electrochemical cell resides the cell components which generate electrochemical energy therewithin. These components may comprise at least one of an anode, a cathode and an electrolyte. A perspective view of a typical prismatic electrochemical cell 10 is shown in FIG. 1. The cell 10 includes an enclosure or casing 12 having spaced-apart front and back walls 14 and 16 joined by curved end walls 18 and 20 and a curved bottom wall 22. The enclosure has an opening 24 provided in a lid portion 26 used for filling the enclosure 12 with an electrolyte after the cell components have been assembled therein. In its fully assembled condition shown in FIG. 1, a closure means 28 is hermetically sealed in opening 24 to close the cell. A terminal pin 30 is electrically insulated from the lid portion 26 and casing 12 by a glass-to metal seal 32, as is well known to those skilled in the art.

### BRIEF DESCRIPTION OF THE DRAWINGS

FIG. 1 is a perspective view of an electrochemical cell 10.

FIG. 2 is a cross-sectional view illustrating an exemplar electrochemical cell 50 comprising an enclosure of the present invention.

FIG. 3 is a top view of an enclosure lid of the present invention.

FIG. 3A is a side view of the enclosure body of the electrochemical cell of the present invention.

FIG. 4 illustrates a perspective view of the enclosure lid being joined to the enclosure body of an electrochemical cell.

FIG. 5 is a micrograph showing the microstructure of the weld joint between an enclosure lid composed of grade 5 titanium and an enclosure body composed of grade 5 titanium.

FIG. 6 is a micrograph showing the microstructure of a weld joint between an enclosure lid composed of grade 2 titanium and an enclosure body composed of grade 5 titanium.

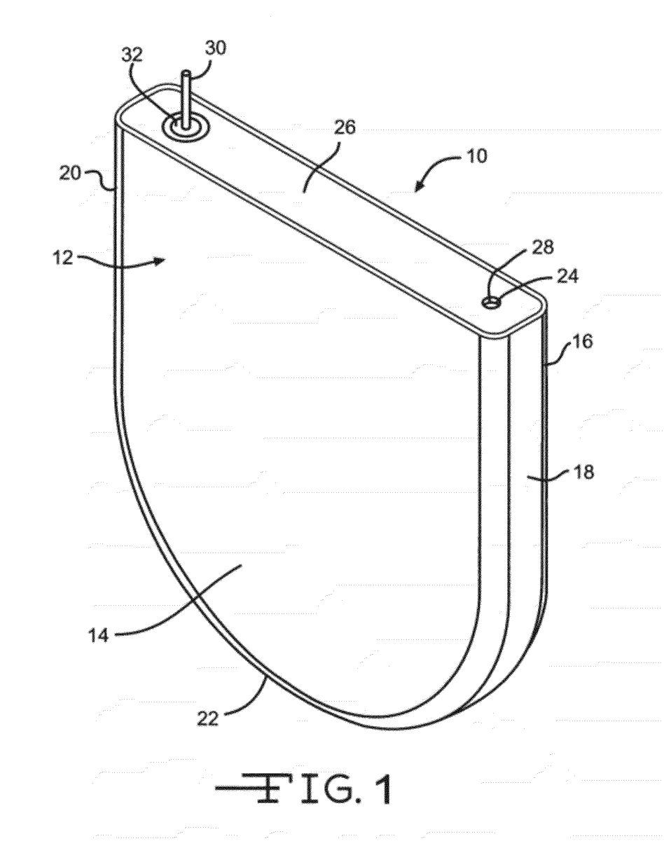

### DETAILED DESCRIPTION OF THE PREFERRED EMBODIMENTS

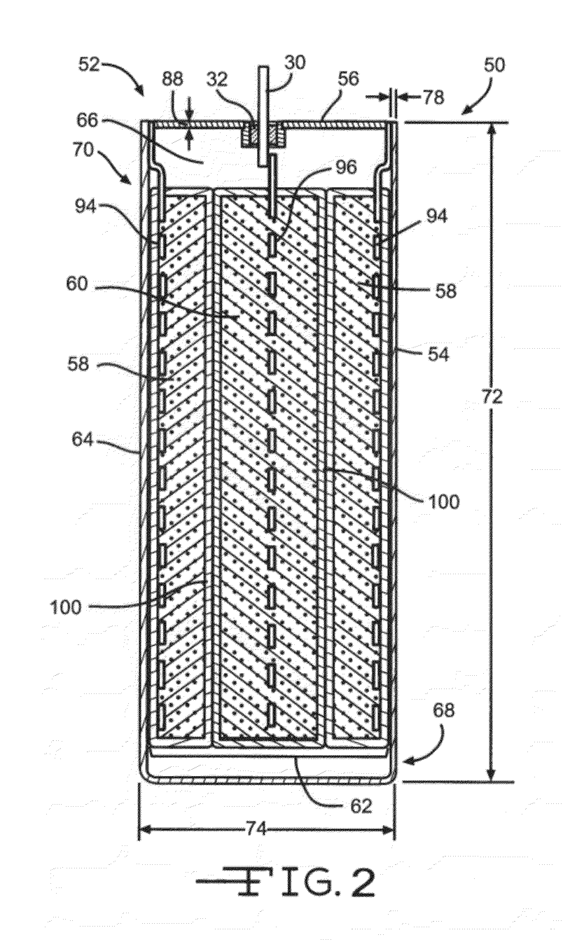

Referring now to FIG. 2 there is shown an exemplar electrochemical cell 50 incorporating an electrochemical cell enclosure 52 of the present invention comprising two dissimilar materials. Specifically, the enclosure 52 comprises an enclosure body portion 54 and an enclosure lid portion 56 that are joined together. In a preferred embodiment, the enclosure body 54 is composed of a material of a relatively high electrical resistivity such as Grade 5 or Grade 23 titanium and the enclosure lid portion 56 is composed of a more ductile material such as Grade 1 or Grade 2 titanium.

Within the enclosure 52 resides at least one of an anode electrode 58 and a cathode electrode 60 providing an electrode assembly 62 that produces electrical energy therewithin. The anode and cathode electrodes 58, 60 are activated by an electrolyte.

In a first embodiment of the present invention, the body portion 54 of the enclosure 52 is formed similarly to that of a container. The body portion 54 of the enclosure 52 comprises a sidewall 64 that encompasses an enclosure space 66 therewithin. The enclosure sidewall 64 extends from a bottom enclosure end 68 to a top open end 70.

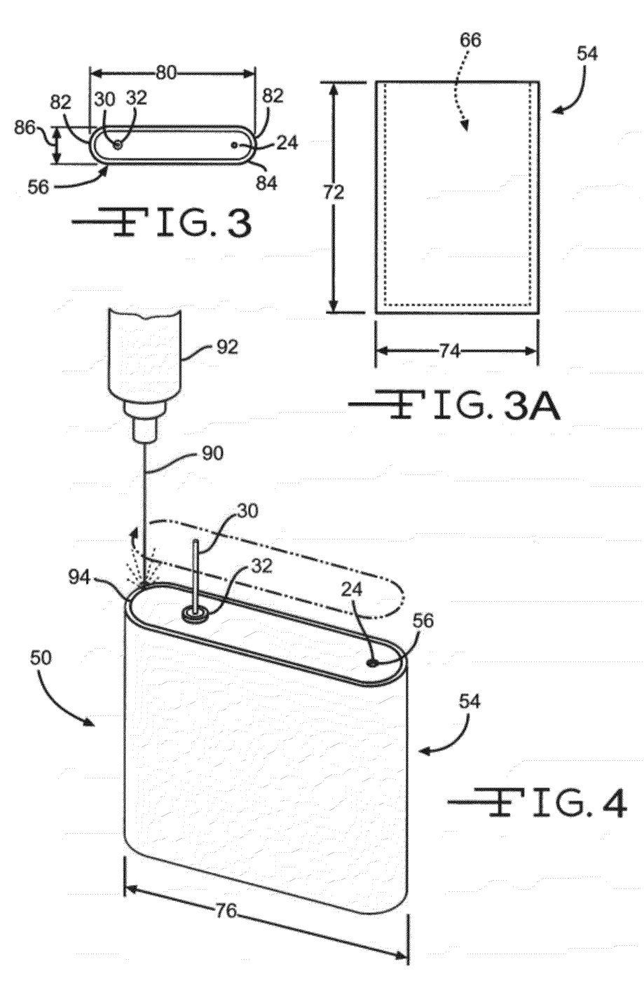

In an embodiment, as shown in FIG. 4, the body portion 54 of the enclosure 52 may have a curved cross-section. Alternatively, the body portion 54 may comprise a cross-section of a shape that is rectangular, elliptical or circular. In a preferred embodiment, the body portion 54 of the enclosure 52 has a body height 72 ranging from about 0.5 inches to about 2 inches, a body width 74 ranging from about 0.1 inches to about 0.5 inches and a body depth 76 (FIG. 4) ranging from about 0.5 inches to about 2.0 inches. In addition, the body portion 54 comprises a body sidewall thickness 78 ranging from about 0.01 inches to about 0.10 inches. The thickness of the sidewall 64 is designed to reduce the occurrence of eddy current heating.

The lid portion 56 of the enclosure 52 is designed to cover and seal the open end 70 of the enclosure 52 therewithin. In an embodiment, the lid portion 56 is of an elongated length 80 with curved ends 82 (FIG. 3). Preferably, the ends 82 of the lid portion 56 have a radius of curvature 84 ranging from about 0.01 inches to about 2.0 inches. Alternatively, the ends of the lid portion 56 may be non-curved with a rectangular or square end. These curved ends 82, which are joined to the body portion of the enclosure 52, reduce mechanical stresses and provide a more robust design.

In a preferred embodiment, the length 80 of the lid portion 56 ranges from about 0.5 inches to about 2 inches, a lid width 86 ranges from about 0.1 inches to about 0.5 inches and a lid thickness 88 ranges from about 0.01 inches to about 0.25 inches.

As previously mentioned, the body portion and lid portions 54, 56 are comprised of biocompatible conductive materials. In a preferred embodiment, the body portion 54 is composed of a material of a relatively high electrical resistivity. Preferably, the electrical resistivity of the body portion 54 ranges from about 1.0×10⁻⁴ ohm-cm to about 2.0×10⁻¹ ohm-cm measured at about 37° C. Most preferably, the body portion 54 of the enclosure 52 is composed of Grade 5 or 23 titanium.

In comparison, lid portion 56 of the enclosure 52 is composed of a biocompatible material that is relatively more ductile, i.e. of a material that is less hard than the material comprising the body portion 54. Preferably, the lid portion 56 is composed of a material having a Vickers hardness (HK100) value ranging from 100 to 300. Most preferably, the lid portion 56 is composed of Grade 1 or 2 titanium.

Although it is preferred that the body portion 54 is composed of a material having a greater electrical resistivity than the material comprising the lid portion 56, it is contemplated that the lid portion 56 could be composed of a material having a greater electrical resistivity than the body portion 54. In this alternate embodiment, the lid portion 56 is composed of Grade 5 or 23 titanium and the body portion 54 is composed of Grade 1 or 2 titanium.

Grade 1 titanium, as defined by ASTM specification B348, is a conductive material of a composition comprising the following weight percentages: carbon (C) less than about 0.10, iron (Fe) less than about 0.20, hydrogen (H) less than about 0.015, nitrogen (N) less than about 0.03, oxygen (O) less than about 0.18, and the remainder comprising titanium (Ti).

Grade 2 titanium, as defined by ASTM specification B348, is a conductive material of a composition comprising the following weight percentages: carbon (C) less than about 0.10, iron (Fe) less than about 0.30, hydrogen (H) less than about 0.015, nitrogen (N) less than about 0.03, oxygen (O) less than about 0.25, and the remainder comprising titanium (Ti),

Grade 5 titanium, as defined by ASTM B348, is a conductive material of a composition comprising the following weight percents: carbon (C) less than about 0.10, iron (Fe) less than about 0.40, hydrogen (H) less than about 0.015, nitrogen (N) less than about 0.05, oxygen (O) less than about 0.20, vanadium (V) ranging from about 3.5 to about 4.5, and the remainder comprising titanium (Ti).

Grade 23 titanium, as defined by ASTM B348, is a conductive material of a composition comprising the following weight percents: carbon (C) less than about 0.08, iron (Fe) less than about 0.25, nitrogen (N) less than about 0.05, oxygen (O) less than about 0.2, aluminum (Al) ranging from about 5.5 to about 6.76, vanadium (V) ranging from about 3.5 to about 4.5, hydrogen (H) less than about 0.015, the remainder titanium (Ti).

Grade 1 titanium has an electrical resistivity of about 4.5×10⁻⁵ ohm-cm and Grade 2 titanium has an electrical resistivity of about 5.2×10⁻⁵ ohm-cm. In comparison, Grade 5 titanium has an electrical resistivity of about 1.78×10⁻⁴ ohm-cm and Grade 23 titanium has an electrical resistivity of about 1.71×10⁻¹ ohm-cm (ASM Material Properties Handbook: Titanium Alloys, Rodney Boyer, Gerhard Weisch, and E. W. Collings, p. 180, 497-498, 2003). As given by the data above, Grades 5 and 23 have an electrical resistivity that is greater than Grades 1 and 2 titanium.

Once the body portion 54 and the lid portion 56 of the enclosure 52 are formed to the desired form and dimensions, the lid portion 56 is positioned over the top open end 70 of the body portion 54. Thus, the positioning of the lid portion 56 with the enclosure body 54 seals the enclosure space 66 therewithin. Alternatively, the lid portion 56 may also be positioned at the bottom end of the body portion 54 of the enclosure 52, sealing the enclosure space 66 therewithin if desired.

Prior to joining the lid portion 56 to the body portion 54 of the enclosure 52, the electrode assembly 62 is positioned within the enclosure space 66 of the body portion 54. Once the assembly 62 is appropriately positioned therewithin, the lid portion 56 is fit over the opening of the body portion 54 of the enclosure 52. In a preferred embodiment, the outer perimeter of the lid portion 56 is positioned within an interior body perimeter formed by the interior wall surface of the body portion 54. Alternatively, the lid portion 56 may be positioned such that the bottom surface of the lid portion 56 contacts the sidewall of the body portion 54.

As shown in FIG. 4, the lid portion 56 is joined to the body portion 54 of the enclosure 52 by welding. In a preferred embodiment, a laser beam 90, emanating from a laser weld instrument 92, is focused between the perimeter of the lid portion 56 and an inner perimeter of the sidewall forming a weld joint 94 therebetween. Alternatively, other joining methods such as resistance welding, arc welding, magnetic pulse welding, or soldering may also be used to join the lid portion 56 to the body portion 54. It will be apparent to those skilled in the art that conventional welding parameters may be used in joining the two portions 54, 56 together.

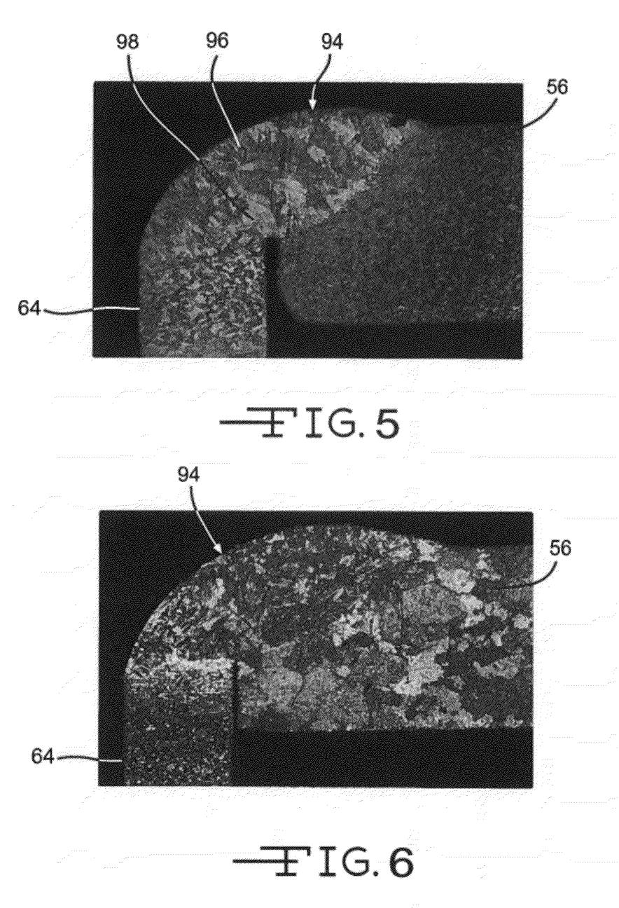

FIGS. 5 and 6 illustrate embodiments of the microstructure of the weld joint 94 between the lid and body portions 56, 54 of the enclosure 52. Specifically, FIG. 5 shows the microstructure of a laser weld joint 94 formed between a lid portion 56 and the body portion 54 both of Grade 5 titanium. FIG. 6 shows the microstructure of the weld joint 94 formed between the lid portion 56 comprised of Grade 1 titanium and the enclosure body portion 54 comprised of Grade 5 titanium. More specifically, FIG. 6 shows the microstructure of a laser weld joint 94 formed between the Grade 1 titanium lid 56 and the Grade 5 titanium body portion 54.

As can be seen in the micrograph of FIG. 5, the microstructure exhibits a mirror planes area 96 inter-dispersed with titanium grain structures 98. In comparison, the microstructure shown in FIG. 6, exhibits a random titanium grain structure, which is structurally stronger in terms of its tensile strength than the mirror planes of FIG. 5.

A series of micro-hardness measurements were taken o weld joints shown in FIGS. 5 and 6. Table I shown below, details the micro-hardness measurements of the weld joint 94 formed between the lid and body portions 56, 54 of the enclosure 52.

| | Body Portion | Lid Portion | Weld Joint |
|---|---|---|---|
| HK100 | Hardness | Hardness | Hardness |
| Grade 5 Ti Body | 350-400 | 320-440 | 410-440 |
| Grade 5 Ti Lid | | | |
| Grade 5 Ti Body | 350-400 | 100-200 | 220-320 |
| Grade 1 Ti Lid | | | |

As shown above, the micro-hardness measurements of the weld joint between the Grade 5 titanium body portion 54 and Grade 1 titanium lid portion 56 are lower in comparison to the micro-hardness measurements of the weld joint between the Grade 5 Ti body and lid portions 54, 56. As shown by the data above, the weld joint between the body portion and lid portion composed of titanium Grades 5 and 1 respectively are less brittle and therefore are more robust than the weld joint between the Grade 5 titanium body and lid portions 54, 56.

Based on the measured micro-hardness values above, a weld joint between Grades 5 or 23 titanium to that of Grades 1 or 2 titanium is preferred to that of a weld joint between two pieces of Grade 5 titanium. As shown above, a weld joint, specifically a laser weld joint, formed between the different grades of titanium having a HK100 Vickers micro-hardness ranging from about 150 to 350 is preferred.

In addition, a pressure test was performed which compared the strength and integrity of the different weld joints 94 of the cell enclosures 52. A total of ten enclosures 52 were tested. Five enclosures were constructed with Grade 5 titanium body and lid portions 54, 56, and five enclosures 52 were constructed with a combination of Grade 5 titanium body portion 54 and a Grade 1 titanium lid 56. A laser weld 94 was used to join and seal the lid portion. 56 to the body portion 54 for all enclosure samples.

During the test, a stream of water was introduced into the enclosure space 66 of each of the enclosures 52 until the weld joint 94 ruptured. The increasing pressure, in pounds per square inch (PSI), was measured and the resulting rupture pressure was recorded. Results of the pressure test showed that the weld joint 94 between the Grade 5 titanium body portion 54 and the Grade 1 lid portion 56, withstood an average pressure of about 1,497 PSI, whereas, the weld joint 94 between the Grade 5 titanium enclosure body and lid portions 54, 56, withstood an average of about 767 PSI. Thus, the enclosure 52 comprising the Grade 5 titanium body portion 54 and the Grade 1 titanium lid. 56, with the greater rupture pressure, is considered to be more robust than the enclosure 52 comprising the Grade 5 titanium body and lid portions 54, 56.

Referring back to FIG. 2 of the exemplar electrochemical cell 50 of the present invention the cell 50 is constructed in what is generally referred to as a case negative orientation with the anode components 58 electrically connected to the enclosure or casing body or lid portions 54, 56 via the anode current collector 94 while the cathode components 60 are electrically connected to a terminal pin 30 via a cathode current collector 96. Alternatively, a case positive cell design may be constructed by reversing the connections. In other words, terminal pin 30 is connected to the anode components 58 via the anode current collector 94 and the cathode components 60 are connected to the casing body or lid portions 54, 56 via the cathode current collector 96.

Both anode current collectors 94 and the cathode current collector 96 are composed of an electrically conductive material. It should be noted that the electrochemical cell 50 of the present invention, as illustrated in FIG. 2, can be of either a rechargeable (secondary) or non-rechargeable (primary) chemistry of a case negative or case positive design. The specific geometry and chemistry of the electrochemical cell 50 can be of a wide variety that meets the requirements of a particular primary and/or secondary cell application.

As previously mentioned, the present invention is applicable to either primary or secondary electrochemical cells. A primary electrochemical cell that possesses sufficient energy density and discharge capacity for the rigorous requirements of implantable medical devices comprises a lithium anode or its alloys, for example, Li—Si, Li—Al, Li—B and Li—Si—B. The form of the anode may vary, but preferably it is of a thin sheet or foil pressed or rolled on a metallic anode current collector 34.

The cathode of a primary cell is of electrically conductive material, preferably a solid material. The solid cathode may comprise a metal element, a metal oxide, a mixed metal oxide, and a metal sulfide, and combinations thereof. A preferred cathode active material is selected from the group consisting of silver vanadium oxide, copper silver vanadium oxide, manganese dioxide, cobalt nickel, nickel oxide, copper oxide, copper sulfide, iron sulfide, iron disulfide, titanium disulfide, copper vanadium oxide, and mixtures thereof.

Before fabrication into an electrode for incorporation into an electrochemical cell 50, the cathode active material is mixed with a binder material such as a powdered fluoro-polymer, more preferably powdered polytetrafluoroethylene or powdered polyvinylidene fluoride present at about 1 to about 5 weight percent of the cathode mixture. Further, up to about 10 weight percent of a conductive diluent is preferably added to the cathode mixture to improve conductivity. Suitable materials for this purpose include acetylene black, carbon black and/or graphite or a metallic powder such as powdered nickel, aluminum, titanium and stainless steel. The preferred cathode active mixture thus includes a powdered fluoro-polymer binder present at about 3 weight percent, a conductive diluent present at about 3 weight percent and about 94 weight percent of the cathode active material.

The cathode component 60 may be prepared by rolling, spreading or pressing the cathode active mixture onto a suitable cathode current collector 96. Cathodes prepared as described above are preferably in the form of a strip wound with a corresponding strip of anode material in a structure similar to a “jellyroll” or a flat-folded electrode stack.

In order to prevent internal short circuit conditions, the cathode 60 is separated from the anode 58 by a separator membrane 100. The separator membrane 100 is preferably made of a fabric woven from fluoropolymeric fibers including polyvinylidine fluoride, polyethylenetetrafluoroethylene, and polyethylenechlorotrifluoroethylene used either alone or laminated with a fluoropolymeric microporous film, non-woven glass, polypropylene, polyethylene, glass fiber materials, ceramics, polytetrafluoroethylene membrane commercially available under the designation ZITEX (Chemplast Inc.), polypropylene membrane commercially available under the designation CELGARD (Celanese Plastic Company, Inc.) and a membrane commercially available under the designation DEXIGLAS (C. H. Dexter, Div., Dexter Corp.).

A primary electrochemical cell includes a nonaqueous, ionically conductive electrolyte having an inorganic, ionically conductive salt dissolved in a nonaqueous solvent and, more preferably, a lithium salt dissolved in a mixture of a low viscosity solvent and a high permittivity solvent. The salt serves as the vehicle for migration of the anode ions to intercalate or react with the cathode active material and suitable salts include LiPF₅, LiBF₄, LiAsF₆, LiSbF₆, LiClO₄, LiO₂, LiAlCl₄, LiGaCl₄, LiC(SO₂CF₃)₃, LiN(SO₂CF₃)₂, LiSCN, LiO₃SCF₃, LiC₆F₅SO₃, LiO₂CCF₃, LiSO₆F, LiB(C₆H₅)₄, LiCF₃SO₃, and mixtures thereof.

Suitable low viscosity solvents include esters, linear and cyclic ethers and dialkyl carbonates such as tetrahydrofuran (THF), methyl acetate (MA), diglyme, trigylme, tetragylme, dimethyl carbonate (DMC), 1,2-dimethoxyethane (DME), 1,2-diethoxyethane (DEE), 1-ethoxy,2-methoxyethane (EME), ethyl methyl carbonate, methyl propyl carbonate, ethyl propyl carbonate, diethyl carbonate, dipropyl carbonate, and mixtures thereof. High permittivity solvents include cyclic carbonates, cyclic esters and cyclic amides such as propylene carbonate (PC), ethylene carbonate (EC), butylene carbonate, acetonitrile, dimethyl sulfoxide, dimethyl, formamide, dimethyl acetamide, γ-valerolactone, γ-butyrolactone (GEL), N-methyl-pyrrolidinone (NMP), and mixtures thereof. The preferred electrolyte for a lithium primary cell is 0.8M to 1.5M LiAsF₆ or LiPF₆ dissolved in a 50:50 mixture, by volume, of PC as the preferred high permittivity solvent and DME as the preferred low viscosity solvent.

By way of example, in an illustrative case negative primary cell, the active material of cathode body is silver vanadium oxide as described in U.S. Pat. Nos. 4,310,609 and 4,391,729 to Liang et al., or copper silver vanadium oxide as described in U.S. Pat. Nos. 5,472,810 and 5,516,340 to Takeuchi et al., all assigned to the assignee of the present invention, the disclosures of which are hereby incorporated by reference.

In secondary electrochemical systems, the anode 58 comprises a material capable of intercalating and de-intercalating the alkali metal, and preferably lithium. A carbonaceous anode comprising any of the various forms of carbon (e.g., coke, graphite, acetylene black, carbon black, glassy carbon, etc.), which are capable of reversibly retaining the lithium species, is preferred. Graphite is particularly preferred due to its relatively high lithium-retention capacity. Regardless of the form of the carbon, fibers of the carbonaceous material are particularly advantageous because they have excellent mechanical properties that permit them to be fabricated into rigid electrodes capable of withstanding degradation during repeated charge/discharge cycling.

The cathode 60 of a secondary cell preferably comprises a lithiated material that is stable in air and readily handled. Examples of such air-stable lithiated cathode materials include oxides, sulfides, selenides, and tellurides of such metals as vanadium, titanium, chromium, copper, molybdenum, niobium, iron, nickel, cobalt and manganese. The more preferred oxides include LiNiO₂, LiMn₂O₄, LiCoO₂, LiCo_{0.92}Sn_{0.08}O₂ and LiCo₁₋ₓNiₓO₂, LiFePO₄, LiNiₓMn_{y}Co_{1-x-y}O₂, and LiNiₓCo_{y}Al_{1-x-y}O₂.

The lithiated active material is preferably mixed with a conductive additive selected from acetylene black, carbon black, graphite, and powdered metals of nickel, aluminum, titanium and stainless steel. The electrode further comprises a fluoro-resin binder, preferably in a powder form, such as PTFE, PVDF, ETFE, polyamides and polyimides, and mixtures thereof. The current collector 94, 96 is selected from stainless steel, titanium, tantalum, platinum, gold, aluminum, cobalt nickel alloys, highly alloyed ferritic stainless steel containing molybdenum and chromium, and nickel-, chromium- and molybdenum-containing alloys.

Suitable secondary electrochemical systems are comprised of nonaqueous electrolytes of an inorganic salt dissolved in a nonaqueous solvent and more preferably an alkali metal salt dissolved in a quaternary mixture of organic carbonate solvents comprising dialkyl (non-cyclic) carbonates selected from dimethyl carbonate (DMC), diethyl carbonate (DEC), dipropyl carbonate (DPC), ethyl methyl carbonate (EMC), methyl propyl carbonate (MPC) and ethyl propyl carbonate (EPC), and mixtures thereof, and at least one cyclic carbonate selected from propylene carbonate (PC), ethylene carbonate (EC), butylene carbonate (BC) and vinylene carbonate (VC), and mixtures thereof. Organic carbonates are generally used in the electrolyte solvent system for such battery chemistries because they exhibit high oxidative stability toward cathode materials and good kinetic stability toward anode materials.

The enclosure lid portion 56 comprises an opening to accommodate the glass-to-metal seal/terminal pin feedthrough for the cathode electrode. The anode or counter electrode is preferably connected to the body portion 54 of the enclosure 52 or the lid portion 56. An additional opening is provided for electrolyte filling. The cell is thereafter filled with the electrolyte solution described hereinabove and hermetically sealed such as by close-welding a titanium plug over the fill hole, but not limited thereto.

Now, it is therefore apparent that the present invention has many features among which are reduced manufacturing cost and construction complexity. While embodiments of the present invention have been described in detail, that is for the purpose of illustration, not limitation.

What is claimed is

1. An electrochemical cell comprising:
a) an enclosure having a body portion and a lid portion, the lid portion joined to the body portion;
b) an anode and a cathode separated from direct physical contact by a separator positioned within the enclosure body, and activated with an electrolyte; and
c) wherein the enclosure body portion is comprised of a first material of a greater electrical resistivity than a second material comprising the enclosure lid portion.

2. The electrochemical cell of claim 1 wherein the body enclosure portion is composed of Grade 5 or 23 titanium and the lid enclosure portion is composed of Grade 1 or 2 titanium.

3. The electrochemical cell of claim 1 wherein the body portion is composed of a titanium material comprising vanadium and aluminum.

4. The electrochemical cell of claim 1 wherein the body enclosure portion is composed of a material having an electrical resistivity ranging from about 1.0×10⁻⁴ ohm-cm to about 2.0×10⁻¹ ohm-cm.

5. The electrochemical cell of claim 1 wherein a laser weld joint forms a hermetic seal between the body portion and the lid portion of the enclosure.

6. The electrochemical cell of claim 5 wherein the laser weld joint has a Vickers (HK100) hardness ranging from 150-350.

7. The electrochemical cell of claim 1 wherein the lid portion is joined to either a top end or a bottom end of the body portion of the enclosure.

8. The electrochemical cell of claim 1 of either a primary or a secondary chemistry.

9. The electrochemical cell of claim 1 of a primary chemistry having the anode of an alkali metal and the cathode of a cathode active material selected from the group consisting of a carbonaceous material, a fluorinated carbon, a metal, a metal oxide, a mixed metal oxide, a metal sulfide, and mixtures thereof.

10. The electrochemical cell of claim 1 wherein one of the anode or the cathode is electrically connected to a terminal lead insulated from the lid portion of the enclosure by a glass-to-metal seal comprising an insulating glass.

11. The electrochemical cell of claim 1 of a secondary chemistry having the anode of carbon or graphite and the cathode of a cathode active material selected from the group consisting of LiNiO₂, LiMn₂O₄, LiCoO₂, LiCo_{0.92}Sn_{0.08}O₂, LiCo₁₋ₓNiₓO₂, LiFePO₄, LiNiₓMn_{y}Co_{1-x-y}O₂, and LiNiₓCo_{y}Al_{1-x-y}O₂.

12. An electrochemical cell comprising:
a) an enclosure having a body portion and a lid portion, the lid portion joined to the body portion;
b) an anode and a cathode separated from direct physical contact by a separator positioned within the enclosure body, and activated with an electrolyte; and
c) wherein the enclosure lid portion is comprised of a first material of a greater electrical resistivity than a second material comprising the enclosure body portion.

13. The electrochemical cell of claim 12 wherein the lid enclosure portion is composed of Grade 5 or 23 titanium and the body enclosure portion is composed of Grade 1 or 2 titanium.

14. The electrochemical cell of claim 12 wherein the lid enclosure portion is composed of a material having an electrical resistivity ranging from about 1.0×10⁻⁴ ohm-cm to about 2.0×10⁻¹ ohm-cm.

15. The electrochemical cell of claim 12 of either a primary or a secondary chemistry.

16. The electrochemical cell of claim 12 wherein a laser weld joint forms a hermetic seal between the body portion and the lid portion of the enclosure.

17. The electrochemical cell of claim 16 wherein the laser weld joint has a Vickers (HK100) hardness ranging from 150-350.

18. An electrochemical cell enclosure comprising:
a) a body enclosure portion having a body portion sidewall encompassing an enclosure space therewithin;
b) a lid portion having an elongated length and a lid width, joined to a top and/or a bottom end of the body portion such that the elongated length and lid width of the lid portion seals the enclosure space therewithin; and
c) wherein the enclosure body portion is comprised of a first material of a greater electrical resitivity than a second material comprising the enclosure lid portion.

19. The electrochemical cell enclosure of claim 18 wherein the body enclosure portion is composed of Grade 5 or 23 titanium and the lid enclosure portion is composed of Grade 1 or 2 titanium.

20. The electrochemical cell enclosure of claim 18 wherein the body portion is composed of a titanium material comprising vanadium and aluminum.

21. The electrochemical cell enclosure of claim 18 wherein a laser weld joint forms a hermetic seal between the body portion and the lid portion of the enclosure.

22. The electrochemical cell enclosure of claim 21 wherein the laser weld joint has a Vickers (HK100) hardness ranging from 150-350.

23. The electrochemical cell enclosure of claim 18 wherein an anode and a cathode, separated from direct physical contact by a separator, are positioned within the enclosure body, one of the anode and the cathode electrically connected to a terminal lead insulated from the lid portion of the enclosure by a glass-to-metal seal comprising an insulating glass.

24. The electrochemical cell enclosure of claim 23 wherein the anode and the cathode are of either a primary or a secondary chemistry.

25. A method of providing an electrochemical cell, comprising the steps of:
a) providing a body enclosure portion having a body portion comprising a sidewall encompassing an enclosure space therewithin;
b) providing an anode and a cathode separated from direct physical contact with each other by a separator housed inside the body enclosure portion and activated with an electrolyte;
c) providing an enclosure lid portion having an elongated length and a lid width; and
d) joining the lid portion to the body enclosure, forming a seal therebetween.

26. The method of claim 25 including providing the body enclosure portion is composed of Grade 5 or 23 titanium and the lid enclosure portion is composed Grade 1 or 2 titanium.

27. The method of claim 25 including providing a laser weld joint forming a hermetic seal between the body portion and the lid portion of the enclosure.

28. The method of claim 27 including providing the laser weld joint with a Vickers (HK100) hardness ranging from 150-350.

29. The method of claim 25 including providing the body enclosure portion composed of a material having an electrical resistivity ranging from about 1.0×10⁻⁴ ohm-cm to about 2.0×10⁻¹ ohm-cm.
